(19) United States
(12) Patent Application Publication
(10) Pub. No.: US 2013/0167776 A1
(43) Pub. Date: Jul. 4, 2013

(54) Blanketed Pet Bed

(71) Applicants: Jacqueline M. Schiel, Mission Viejo, CA (US); Chad W. Schiel, Mission Viejo, CA (US)

(72) Inventors: Jacqueline M. Schiel, Mission Viejo, CA (US); Chad W. Schiel, Mission Viejo, CA (US)

(21) Appl. No.: 13/596,841

(22) Filed: Aug. 28, 2012

Related U.S. Application Data
(60) Provisional application No. 61/582,734, filed on Jan. 3, 2012.

(51) Int. Cl. A01K 29/00

(52) U.S. Cl. 119/28.5

(57) ABSTRACT

A pet bed comprising of a pillow-like bottom portion and a plurality of side walls. Inside the side walls and on top of the pillow-like bottom is a blanket. The blanket is secured on all sides of the pet bed between the bottom pillow-like base and all of its surrounding walls. The blanket is sewn into the seam between the base the side walls of the bed or, in another more preferred embodiment, the blanket is secured to the bed by separable means for binding separate pieces of fabric together such as buttons, hook and loop fabric, snaps, or the like. In another embodiment, a plurality of petals are disposed about the circumference of the pet bed to provide a substantially “flower” like design to the pet bed.

### RELATED APPLICATIONS

The present application is related to U.S. Provisional Patent Application Ser. No. 61/582,734, filed on Jan. 3, 2012, which is incorporated herein by reference and to which priority is claimed pursuant to 35 USC 119.

### BACKGROUND

1. Field of the Technology

The disclosure relates to the field of beds for pets, specifically blanketed beds for dogs and cats.

2. Description of the Prior Art

Dogs and other pets frequently create their own beds within the home using blankets, cloths, towels, and whatever other fabric-like materials might be laying around the house. Many dogs typically never lie under the articles, but rather bunch them up and then lay on top of them.

Many other household pets do the same thing and use articles that most homeowners don't want their dogs and cats to sleep on. The currently disclosed pet bed provides a comfortable, moldable, reliable place to bed down. Other pet beds do not offer a stitched in blanket feature, therefore making them to ridged and stiff for most pets to make themselves comfortable. Often then, the result is that the pets do not use their own provided bed and either make their own out of household items or sleep in their owner's bed where optimal comfort can be reached. Because the current blanketed pet bed is one piece, it is economical and requires very little maintenance.

### BRIEF SUMMARY

One preferred embodiment of the current invention comprises a bed for accommodating a pet. The bed includes a bottom portion, at least one wall coupled to the bottom portion, and a blanket coupled to the bottom or to the at least one wall. The bed further includes a plurality of walls coupled to the bottom portion. The walls in some embodiments may define the bed in a substantially rectangular shape.

In one preferred embodiment, the blanket of the bed is removably coupled to the bottom portion or to the at least one wall. In some embodiments, the blanket is removably coupled to the bottom portion or to the at least one wall by means of buttons, hook and loop fabric, or snaps.

In a related embodiment, the blanket of the bed is permanently coupled to the bottom portion or to the at least one wall.

In another embodiment, the blanket of the bed comprises a surface area that is at least twice the size of an area defined by the at least one wall.

In yet another embodiment, at least one wall defines the bed in a substantially circular shape. A plurality of petals coupled to the at least one wall may also be disposed on the bed. Alternatively, a plurality of petals may be coupled to the bottom portion of the bed.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a perspective view of one embodiment of the current pet bed.

FIG. 2 is frontal view of an alternative embodiment of the pet bed seen in FIG. 1.

FIG. 3 is a perspective view of an alternative embodiment of the pet bed seen in FIG. 1.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

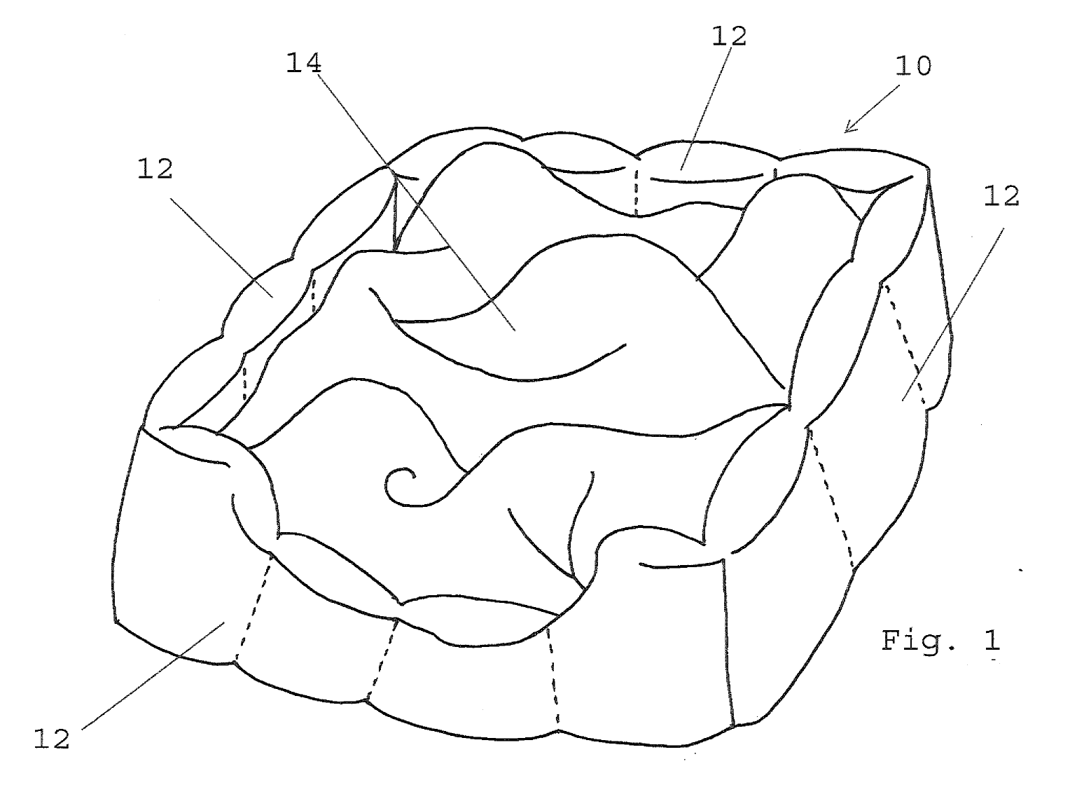

The current invention is a blanketed pet bed as is seen in FIG. 1 and is generally denoted with reference numeral 10. The bed 10 is shown as a substantially rectangle shape in FIG. 1, however it is to be expressly understood that the bed 10 can be round, square, or any other shape known in the art without departing from the original spirit and scope of the invention. The bed 10 comprises of a pillow-like bottom portion (not seen) and a plurality of side walls 12. The size and shape of the bottom and side walls 12 can change to accommodate pets of any size. Inside the side walls 12 and on top of the pillow-like bottom is a blanket 14. The blanket 14 is at least two times the surface area encompassing the bed 10 itself as defined by the plurality of side walls 12. The blanket 14 is secured on all sides of the pet bed 10 between the bottom pillow-like base and all of its surrounding walls 12. The blanket 14 is sewn into the seam between the base the side walls 12 of the bed 10. However in another more preferred embodiment, the blanket 14 is secured to the bed 10 by separable means for binding separate pieces of fabric together such as buttons, hook and loop fabric, snaps, or the like. With the blanket 14 secured in place, this creates an adjustable, non-detachable blanket mound within the outer pet bed walls 12 as seen in FIG. 1. The blanket 14 and side walls 12 of the bed 10 are preferably comprised of light weight, machine washable fabric such as cotton, polyester, or other synthetic blends in the art now known or later devised.

A pet enters the bed 10 by surmounting the side walls 12 and getting on top of the blanket 14. The pet then makes itself comfortable by manipulating the blanket 14 according to its taste. Because the blanket 14 is coupled to the inner surface of the side walls 12, the blanket 14 remains within the confines of the bed 10 no matter how much the pet manipulates it. Once comfortable, the pet lays on the blanket 14 within the bed 10.

As a result of this product, pet owners have the ability to encourage use of the blanketed pet bed 10 rather than letting pets use household items for their bedding purposes. It is a traditional pet bed and moldable attached blanket all in one. Hence it provides the most comfort for pets that prefer sleeping and lying on blankets rather than in traditional pet beds.

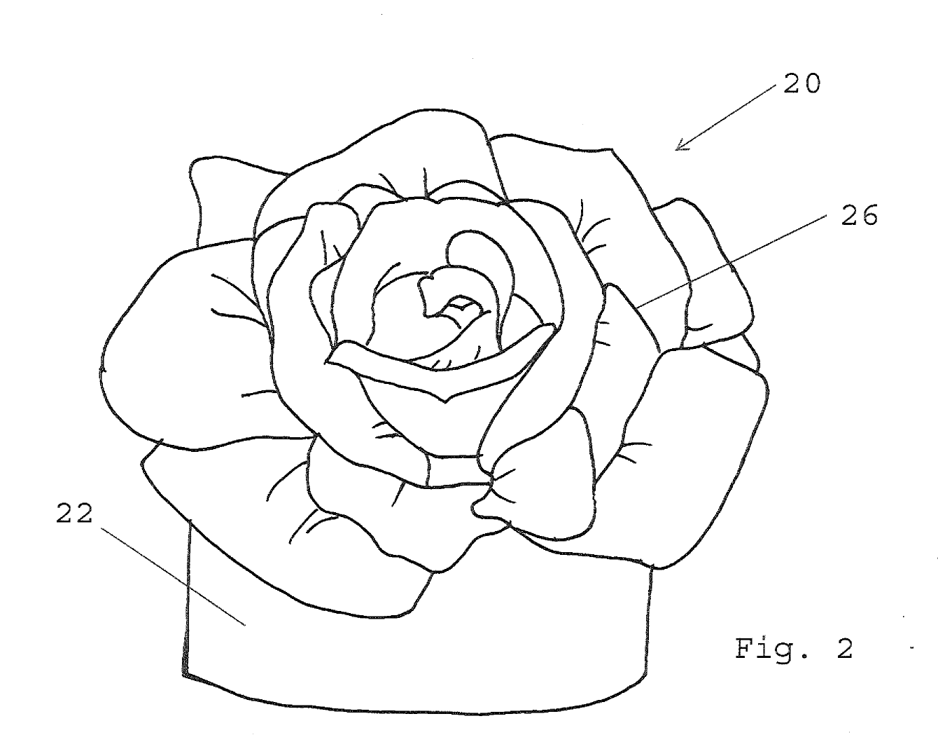

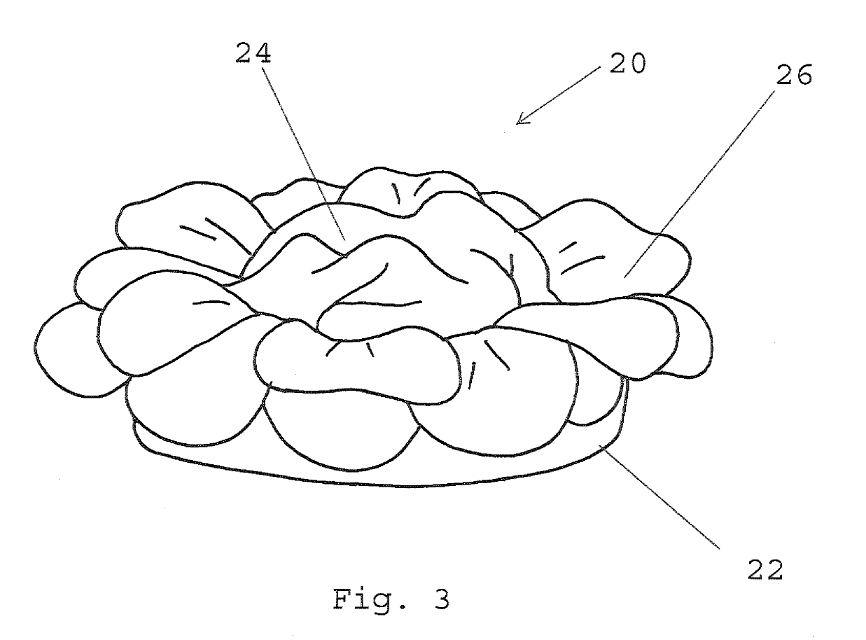

FIGS. 2 and 3 shows an alternative embodiment of the blanket pet bed 20. Here, the pet bed 20 comprises a wall 22 which is semi-rigid and substantially circular in shape. The pet bed 20 comprises a soft pillow-like bottom portion (not seen) in the center of the bed 20. The pet bed 20 also comprises a blanket 24 in FIG. 3 which is removably coupled between the wall 22 and the pillow-like bottom as described above. Also as seen in FIG. 3, a plurality of petals 26 are disposed about the circumference of the pet bed 20. Each of the petals 26 are comprised of a soft, durable machine-safe fabric known in the art and are sewn or otherwise coupled to the circular wall 22 to provide a substantially “flower” like design to the pet bed 20. In one particular embodiment seen in FIG. 2, the pet bed 20 may comprise petals 26 disposed across its entire top surface of the bottom portion, thus eliminating the need of any blanket 24.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A bed for accommodating a pet comprising:
a bottom portion;
at least one wall coupled to the bottom portion; and
a blanket coupled to the bottom or to the at least one wall.

2. The bed of claim 1 further comprising a plurality of walls coupled to the bottom portion.

3. The bed of claim 1 where the blanket is removably coupled to the bottom portion or to the at least one wall.

4. The bed of claim 1 where the blanket is permanently coupled to the bottom portion or to the at least one wall.

5. The bed of claim 1 where the blanket comprises a surface area that is at least twice the size of an area defined by the at least one wall.

6. The bed of claim 1 where the at least one wall defines the bed in a substantially circular shape.

7. The bed of claim 6 further comprising a plurality of petals coupled to the at least one wall.

8. The bed of claim 6 comprising a plurality of petals coupled to the bottom portion.

9. The bed of claim 2 where the plurality of walls coupled to the bottom portion define the bed in a substantially rectangular shape.

10. The bed of claim 3 where the blanket is removably coupled to the bottom portion or to the at least one wall by means of buttons, hook and loop fabric, or snaps.
